(19) United States
(12) Patent Application Publication
(10) Pub. No.: US 2017/0088419 A1
(43) Pub. Date: Mar. 30, 2017

(54) Membrane-Based Gas Separation Processes to Produce Synthesis Gas With a High CO Content

(71) Applicant: Membrane Technology and Research, Inc., Newark, CA (US)

(72) Inventors: Nicholas P. Wynn, Redwood City, CA (US); Douglas Gottschlich, Redwood City, CA (US); Alvin Ng, Milpitas, CA (US)

(73) Assignee: Membrane Technology and Research, Inc., Newark, CA (US)

(21) Appl. No.: 15/371,829

(22) Filed: Dec. 7, 2016

Related U.S. Application Data
(62) Division of application No. 13/829,190, filed on Mar. 14, 2013.

(51) Int. Cl. C01B 3/50; C10G 2/00; B01D 53/22; C01B 3/38

(52) U.S. Cl. CPC C01B 3/501; C01B 3/38; C10G 2/30; B01D 53/226; C01B 2203/0233; C01B 2203/0405; C01B 2203/0475; C01B 2203/062; C01B 2203/1241

(57) ABSTRACT

A process for producing syngas with a high content of carbon monoxide, reflected in a high CO:CO₂ ratio. The process involves integrating membrane-based gas separation and steam methane reforming.

### CROSS-REFERENCE TO RELATED APPLICATIONS

This application is a divisional of U.S. application Ser. No. 13/829,190, filed on Mar. 14, 2013, the disclosure of which is hereby incorporated herein by reference in its entirety.

### FIELD OF THE INVENTION

The invention relates to membrane-based gas separation processes for the production of synthesis gas (“syngas”) with a high yield of carbon monoxide from a light, hydrocarbon feedstock. Carbon dioxide recovered from one or more membrane separation steps is recycled within the process.

### BACKGROUND OF THE INVENTION

Synthesis gas or syngas—a mixture of carbon monoxide, carbon dioxide, and hydrogen—is used as a feedstock for making diverse hydrocarbon products, including methanol and synthetic fuels and lubricant oils.

Syngas can be produced by steam methane reforming (SMR). At low to moderate pressures and at high temperatures, methane reacts with steam on a nickel catalyst according to the following reforming reactions:

CH₄+H₂O→CO+3H₂ (1)

CO+H₂O→CO₂+H₂, and the reverse reaction (2)

H₂+CO₂→H₂O+CO. (3)

Overall, these reactions are highly endothennic, and maintaining reaction temperature by external beating is a critical part of the process.

If the syngas is to be used as a hydrocarbon manufacturing feedstock, it is usually desirable to maximize CO production and minimize CO₂ production, because CO is a valuable reagent, whereas CO₂ is not. Because reaction (3) is favored by high temperature, the reformer is generally ran at as high a temperature as practicable, even as high as 900° C. for example.

High methane conversion is also favored by low operating pressure, because the reforming, reactions increase the volume of gas. By way of illustration, FIG. 7 shows the dependence of CO yield (moles CO generated per mole of methane feed) on reformer temperature for reformer pressures of 5 bar and 25 bar, if the steam to methane ratio in the reformer feed is 3:1. At a reformer pressure of 25 bar and temperature of 850° C., about 50% of the methane feed is converted to CO, 28% is converted to CO₂ and the remaining 22% passes through as unreacted methane. By contrast, at a pressure of 5 bar, the same level of 50% CO yield can be reached at a temperature of only 740° C. If the temperature were maintained at 850° C., the yield at 5 bar would be above 60%.

Despite the ability to achieve better yield at low pressure, reformers are ran at elevated pressure, typically 20-30 bar, to facilitate both heating of the reactant gases and heat recovery from the product gases, which is necessitated by the highly endothermic nature of the reactions.

The above reactions relate to methane conversion. If ethane or higher paraffins are constituents of the reformer feed, then steam reforming will generate 2+1/n moles of hydrogen for every mole of carbon monoxide and 3+1/n moles of hydrogen for every mole of carbon dioxide for each constituent hydrocarbon represented by the generic formula CₙH₂ₙ₊₂.

Another option is to make syngas by gasification and oxidation reactions, in which oxygen or air is mixed with a gas, liquid or solid hydrocarbon feed at suh-stoichiometric ratios. If the hydrocarbon is methane, for example, the following reactions occur:

CH₄+½O₂→CO+2H₂ (4)

CH₄+O₂→CO₂+2H₂ (5)

H₂+½O₂→H₂O (6)

These reactions are exothermic. In some situations, both oxygen (or air) and steam are fed to the syngas production process. The presence of steam in the feed stream suppresses the hydrogen consuming reaction (6). If the mix of steam reforming and oxidation results in a balance of endothermic and exothermic reactions, the process is termed autothermai reforming.

Whatever reaction or combination of reactions are used, designing an SMR unit to operate at very high temperatures incurs high capital costs. Metallurgical requirements are stringent, heat transfer areas are high and designs are complex to accommodate thermal expansion. In practice, even large scale reformers are restricted to operating temperatures of 850-900° C. Autothermal reforming minimizes the heat transfer area and thereby facilitates operational temperatures up to 1,000° C. However, unless nitrogen can be accommodated in the product gas, autothermai reforming requires large quantities of oxygen, substantially increasing operating costs.

Despite efforts to balance the various parameters and considerations discussed above to achieve, high CO yield, it remains the case that raw syngas often contains a substantial CO₂ content. For example, after water removal, the concentration of CO₂ in the gas may be as high as 10%, 15% or even higher. Expressing the CO production in terms of molar proportions of CO and CO₂ produced, the CO:CO₂ ratio may often be as low as about 2:1 or even lower. Before the syngas is used as a feedstock, it may be necessary to remove some or most of the carbon dioxide content, thereby necessitating the use of costly, complex or inconvenient treatment steps.

In addition to maximizing the CO:CO₂ ratio, it is often desirable to adjust the CO to hydrogen ratio. One of the most important uses for syngas is in GTL (gas-to-liquids) syntheses of liquid hydrocarbons, including synthetic gasoline, other fuels and lubricant oils. In the Fischer-Tropsch process, for example, CO and hydrogen are combined in a number of reactions, according to the overall stoichiometry:

nCO+(2n+1)H₂=CₙH₂ₙ₊₂+nH₂O (7)

In the event that a C8 product is being manufactured, for example, the above stoichiometry requires a hydrogen:CO ratio of 17/8, i.e. 2.125, for the process feed. In contrast, a methane-fed reformer usually yields a syngas with at least a 3:1 hydrogen:CO ratio. When the objective is to generate a suitable feed for Fischer-Tropsch reactions, therefore, it is desirable to reduce the hydrogen:CO ratio to below 3:1, more preferably to below 2.5:1, and most preferably to below about 2.3:1.

Besides managing the temperature and pressure operating conditions carefully, CO production from a given supply of natural gas or methane can be increased by adding CO₂ from an outside source to the reformer feed. This method, known as “dry reforming”, has been used in natural gas steam methane reforming. Although this technique results in more carbon monoxide in the product syngas, it does not increase the yield of CO from the hydrocarbon fed to the reformer.

It is also known to remove CO₂ from the raw syngas itself by absorption/stripping, then return the recovered CO₂ to the reformer feed. However, as well as high energy consumption, absorption/desorption processes are complicated to control and use multiple pieces of equipment, including absorber and stripping columns, heat exchangers, pumps, valves and extensive instrumentation. Furthermore, the absorbent introduces an additional fluid into the processing system, and this fluid may have toxic or other undesirable characteristics, requiring costly or inconvenient treatment or disposal.

Despite all the options described above for maximizing generation of CO from hydrocarbon feedstocks, there remains a need for a process that can provide good CO yield without requiring excessively high reforming temperatures, low operating pressures, the addition of oxygen, or the importation of CO₂ from an external source. It would also be very desirable to avoid the complexity and operational drawbacks of absorption/desorption. This need is particularly pronounced at a small scale of operation, where the above drawbacks have a proportionately greater impact on the process productivity and economics.

There also remains a related need for processes in which a low hydrogen:carbon monoxide ratio, preferably below 3:1, can be achieved.

### SUMMARY OF THE INVENTION

The invention is a process for producing syngas with a high content of carbon monoxide, reflected in a high CO:CO₂ ratio. The process involves integrating membrane-based gas separation and steam methane reforming.

The membrane-based gas separation step uses a membrane that exhibits selectivity for carbon dioxide over hydrogen, and for carbon dioxide over carbon monoxide. This step accepts raw syngas from a steam reformer and produces a carbon dioxide enriched stream that is returned to the reformer as part of the feed to the reforming reactions. The residue from the membrane separation step is a syngas product with an elevated CO content compared with what could be produced, under like reforming conditions, from the same amount of hydrocarbon feed absent the membrane separation. The return of CO₂ suppresses the CO₂-producing reactions and promotes the CO-producing reactions in the reformer, thereby increasing the CO yield and the ratio of CO to CO₂ in the syngas product.

The process reduces, and in some cases can obviate entirely, the need for downstream CO₂ removal technology, enabling the syngas product to be sent directly as feedstock to a gas-to-liquids process or other use.

In a basic embodiment, the process of the invention comprises the following steps:
(a) reacting a gas mixture comprising steam and methane in a reformer train to form a raw syngas stream comprising hydrogen, carbon monoxide and carbon dioxide;
(b) providing a membrane having a feed side and a permeate side, wherein the membrane exhibits a selectivity to carbon dioxide over hydrogen;
(c) passing at least a portion of the raw syngas stream as a feed stream across the feed side;
(d) withdrawing from the feed side a syngas product stream depleted in carbon dioxide compared with the feed stream, the syngas product stream containing carbon monoxide and carbon dioxide in a molar ratio of at least about 3:1;
(e) withdrawing from the permeate side a permeate stream enriched in carbon dioxide compared with the feed stream;
(f) returning at least a portion of the permeate stream as a feedstock to the reformer train.

The steam methane reforming step or steps (a) are carried out in a steam reformer train. The reformer train includes one or more individual reactors carrying out at least reaction (1) and optionally any of the other reactions discussed above, particularly (2) or (3).

The various reactions produce a raw syngas stream at high temperature. Before the raw syngas stream is passed to the membrane separation steps, therefore, it is usually cooled, such as to below 120° C. or 100° C. This will both condense water from the stream and enable polymeric membranes that could not tolerate high temperatures to be used in the membrane separation step.

Also as mentioned above, reforming reactions are typically carried out at a pressure of a few tens of bar, such as 20 or 30 bar. The raw syngas may be passed to the membrane feed side without adjusting the pressure. Alternatively, the driving force for operating the membrane separation step may be increased by compressing the raw syngas.

If the membrane separation step is operated with the permeate side at a lower pressure than the operating pressure of the reformer, the permeate stream should be recompressed before being sent to the reformer.

Any membranes able to provide adequate separation of carbon dioxide from hydrogen and carbon monoxide may be used. Preferably, the membranes are polymeric membranes that offer a selectivity in favor of carbon dioxide over hydrogen of at least about 5.

The syngas product has a high carbon monoxide content compared with steam methane reforming processes carried out under otherwise similar conditions that are not integrated with membrane-based gas separation. Preferably, the carbon monoxide content of the product syngas stream (after water removal) is at least about 15%.

The ratio of carbon monoxide to carbon dioxide is also higher than in comparable non-membrane-integrated processes, and is preferably at least about 3:1. Likewise, especially if a hydrogen-selective membrane separation step is included, as discussed below, the hydrogen:CO ratio may be lower than in comparable non-membrane-integrated processes, and is preferably below 3:1.

The product syngas from the integrated process may be used as desired. The processes of the invention are believed to be particularly beneficial in preparing syngas for use in gas-to-liquids processes, and more specifically as feedstock for Fischer-Tropsch synthesis of synthetic gasolines and other fuels and lubricants.

The embodiments described above use membranes that are selective in favor of carbon dioxide over hydrogen. It is also possible to include membranes that are selective to hydrogen over carbon dioxide. This reduces the amount of hydrogen that is recycled to the reformer train with the recovered carbon dioxide, thereby enabling more effective CO₂ recycling, as well as reducing the ratio of hydrogen to carbon monoxide in the treated syngas.

An embodiment that incorporates both a carbon-dioxide-selective membrane separation step and a hydrogen-selective membrane separation step comprises:
(a) reacting a gas mixture comprising steam and methane in a reformer train to form a raw syngas stream comprising hydrogen, carbon monoxide and carbon dioxide;
(b) providing a first membrane unit containing a first membrane having a first feed side and a first permeate side, wherein the first membrane exhibits a selectivity to carbon dioxide over hydrogen;
(c) passing at least a portion of the raw syngas stream as a first feed stream across the first feed side;
(d) withdrawing from the first feed side a syngas product stream depleted in carbon dioxide compared with the first feed stream, the syngas product stream containing carbon monoxide and carbon dioxide in a molar ratio of at least about 3:1, and containing hydrogen and carbon monoxide in a molar ratio less than about 3:1;
(e) withdrawing from the first permeate side a first permeate stream enriched in carbon dioxide compared with the feed stream;
(f) providing a second membrane unit containing a second membrane having a second feed side and a second permeate side, wherein the second membrane exhibits a selectivity to hydrogen over carbon dioxide;
(g) passing at least a portion of the first permeate stream as a second feed stream, across the second feed side;
(h) withdrawing from the second feed side a second residue stream depleted in hydrogen compared with the second feed stream;
(i) withdrawing from the second permeate side a second permeate stream enriched in hydrogen compared with the second feed stream;
(j) passing at least a portion of the second residue stream as a feedstock to the reformer train.

Just as with the embodiments using only the carbon dioxide selective membrane, it is preferred to cool, the raw syngas and to condense water from the stream before the first membrane separation step.

In this embodiment, it is generally preferred to recompress the permeate from the first membrane unit to a pressure similar to the reformer operating pressure before feeding the first permeate to the second, hydrogen-selective membrane step. In this case, the residue from the hydrogen-selective membrane separation step may be introduced to the reformer feed without the need for further compression. In the alternative, the raw syngas from the reformer may be compressed upstream of the first membrane separation step. In this case, the permeate side of the first membrane step may conveniently be maintained at about reformer pressure, again enabling the residue stream from the second membrane separation step to be returned to the reformer without additional recompression.

Any membranes able to provide adequate separation of hydrogen from carbon dioxide and carbon monoxide may be used for the second membrane separation step. Preferably, the membranes are polymeric membranes that offer a selectivity in favor of hydrogen over carbon dioxide of at least about 5. Preferences for the membranes of the first step are as already described.

Embodiments incorporating both carbon dioxide selective and hydrogen selective membranes are especially beneficial in providing a product syngas with a low hydrogen:CO ratio. Ratios below 3:1, and in favorable cases below 2.5:1, such as 2.3:1, 2.2:1 or even 2.1:1 can be achieved. As with the previous embodiments, the syngas can be used in any desired fashion, but is especially useful as a feedstock to a GTL process.

Optionally, if further hydrogen removal is desired, a third membrane separation step using a hydrogen-selective membrane may be carried out on the raw syngas before it is passed to the carbon-dioxide selective membrane unit.

In another aspect, the invention integrates three operations: membrane-based gas separation, steam methane reforming and gas-to-liquids conversion of the product syngas. In one such embodiment, a membrane that exhibits selectivity in favor of hydrogen over carbon dioxide is used, and the carbon-dioxide-enriched residue stream from the membrane separation step(s), in which the ratio of hydrogen to CO has been reduced, is passed to a Fischer-Tropsch (FT) process or the like. In the FT process, hydrogen and carbon monoxide are consumed, generally according to the overall scheme of reaction (7), to yield a liquid hydrocarbon product.

The off-gas or tail gas from the FT steps is rich in carbon dioxide and is returned to the steam reformer to suppress further CO₂ production and enhance CO yield as in the embodiments already discussed. Such an embodiment comprises the following steps:
(a) reacting a gas mixture comprising steam and methane in a reformer train to form a raw syngas stream comprising hydrogen, carbon monoxide and carbon dioxide:
(b) providing a membrane unit containing a membrane having a feed side and a permeate side, wherein the membrane exhibits a selectivity to hydrogen over carbon dioxide;
(c) passing at least a portion of the raw syngas stream as a feed stream across the feed side;
(d) withdrawing from the feed side an adjusted syngas stream depleted in hydrogen compared with the feed stream;
(e) withdrawing from the permeate side a permeate stream enriched in hydrogen compared with the feed stream;
(f) passing at least a portion of the adjusted syngas stream to a reactor and there reacting carbon monoxide and hydrogen to produce a raw hydrocarbon product in the C4-C15 range;
(g) separating the raw hydrocarbon product, thereby producing a hydrocarbon product stream and a tail gas stream comprising carbon dioxide;
(h) passing at least a portion of the tail gas stream as a feedstock to the reformer train.

In this embodiment, the preferences for operating conditions, membrane selectivity, and so on are as expressed for the previous embodiments described above. Water is commonly removed by cooling and condensing before the syngas is used in the reaction step (f). Depending on the preferred operating pressures for the steam methane reformer and the GTL reactor, the pressure of the syngas stream may be adjusted, such as by compression before the membrane separation step or by reducing the pressure after the membrane separation step.

In a second embodiment incorporating membrane-based gas separation, steam methane reforming and hydrogen+CO reaction steps, the membrane separation step is performed on the tail gas from the hydrocarbon forming reactor. In such as embodiment, the following steps are included:
(a) reacting a gas mixture comprising steam and methane in a reformer train to form a syngas stream comprising hydrogen, carbon monoxide and carbon dioxide:
(b) passing at least a portion of the syngas stream to a reactor and there reacting carbon monoxide and hydrogen to produce a raw hydrocarbon product in the C4-C15 range;
(c) separating the raw hydrocarbon product, thereby producing a hydrocarbon product stream and a tail gas stream comprising carbon dioxide;
(d) providing a membrane unit containing a membrane having a feed side and a permeate side, wherein the membrane exhibits a selectivity to hydrogen over carbon dioxide;
(e) passing at least a portion of the tail gas stream as a feed stream across the feed side;
(f) withdrawing from the permeate side a permeate stream enriched in hydrogen compared with the feed stream;
(g) withdrawing from the feed side a recycle stream enriched in carbon dioxide and depleted in hydrogen compared with the feed stream;
(h) passing at least a portion of the recycle stream as a feedstock to the reformer train.

In the aspects in which the invention involves three integrated steps, a reforming step, a membrane gas separation step and a reaction step producing a hydrocarbon product, the ratio of hydrogen to CO in the syngas that is fed to the hydrocarbon producing reactor is typically less than 3:1, and preferably is less than about 2.3:1.

### BRIEF DESCRIPTION OF THE DRAWINGS

FIG. 1 is a schematic drawing of a basic embodiment of the process of the invention in which a membrane gas separation step, using membranes selective in favor of carbon dioxide over carbon monoxide and hydrogen, is integrated with a steam methane reforming step.

FIG. 2 is a schematic drawing of an embodiment of the process of the invention including two membrane gas separation steps, one using membranes selective in favor of carbon dioxide over carbon monoxide and hydrogen, the other using membranes selective in favor of hydrogen over carbon dioxide, integrated with a steam methane reforming step.

FIG. 3 is a schematic drawing of an embodiment of the process of the invention including three membrane separation steps, one using membranes selective in favor of carbon dioxide over carbon monoxide and hydrogen, the other two using membranes selective in favor of hydrogen over carbon dioxide, integrated with a steam methane reforming step,

FIG. 4 is a schematic drawing of an embodiment of the process of the invention in which the feed to the membrane separation step is compressed prior to entering the membrane separation unit.

FIG. 5 is a schematic drawing of a first embodiment of the process of the invention in which three unit operations: membrane-based gas separation, steam methane reforming, and reaction of CO and hydrogen to form a hydrocarbon product, are integrated.

FIG. 6 is a schematic drawing of a second embodiment of the process of the invention in which three unit operations: membrane-based gas separation, steam methane reforming, and reaction of CO and hydrogen to form a hydrocarbon product, are integrated.

FIG. 7 is a graph showing carbon monoxide yield in teams of mole-per-mole conversion of methane to CO as a function of the reformer outlet temperature, for reformers operating at 25 bar and 5 bar, without an integrated membrane separation step.

FIG. 8 is a graph showing carbon monoxide yield in terms of mole-per-mole conversion of methane to CO as a function of the reformer outlet temperature, for reformers operating at 25 bar and 5 bar without and with an integrated membrane separation step.

### DETAILED DESCRIPTION OF THE INVENTION

The terms “natural gas” and “methane” are used interchangeably herein.

The terms “reformer”, “reformer train”, “steam reformer” and “steam methane reformer” as used herein refer to any equipment or train of equipment, that produces syngas from a starting feedstock that includes at least methane and steam.

Gas percentages and ratios given herein are molar unless stated otherwise.

Pressures as given herein are in bar absolute unless stated otherwise.

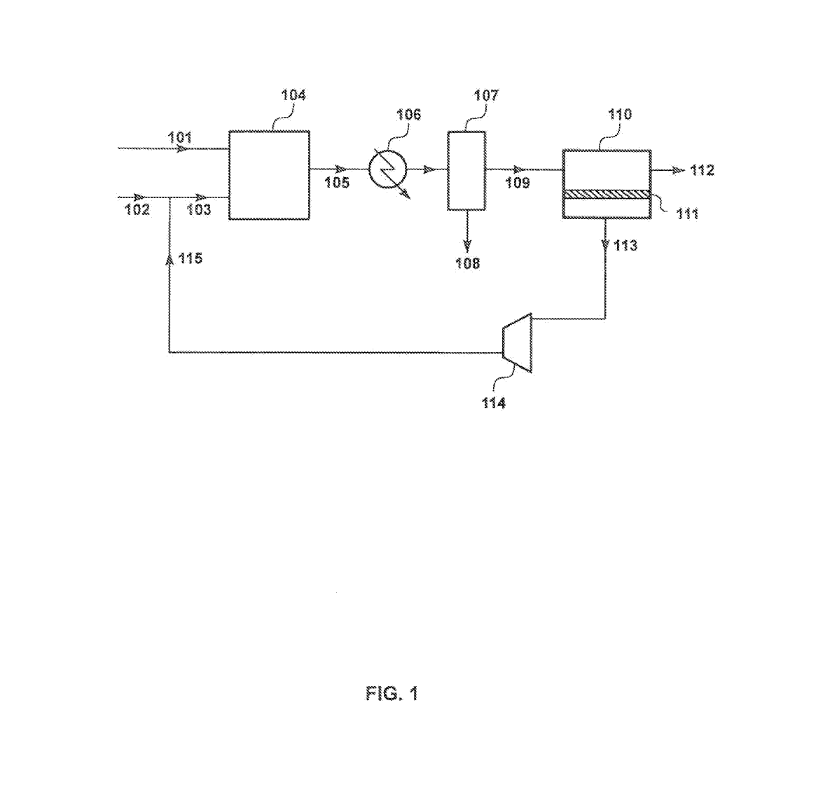

A basic embodiment of the invention that comprises two integrated steps—a membrane-based gas separation step and a steam methane reforming step—is shown in FIG. 1.

It will be appreciated by those of skill in the art that FIG. 1 and the other FIGS. showing process schemes herein are very simple block diagrams, intended to make clear the key unit operations of the processes of the invention, and that actual process trains may include additional steps of a standard type, such as heating, chilling, compressing, condensing, pumping, monitoring of pressures, temperatures, flows, and the like. It will also be appreciated by those of skill in the art that the unit operations may themselves be performed as multiple steps or in a train of multiple pieces of equipment.

Referring to FIG. 1, steam, 101, is fed into a steam methane reforming step, 104. A gaseous hydrocarbon feed stream, 102, usually but not necessarily comprising methane, is combined with stream, 115, (which is discussed below) and passed as feed stream, 103, to the reformer 104. In the alternative, streams 102 and 111 may be introduced separately into the reformer.

The reforming step or steps comprise reactions of the type discussed in the Background section above, and are carried out under any convenient reforming conditions and in a reformer train including one or more individual reactors, as is well known in the art. The train may contain upfront equipment to purify the gas feedstock, boilers or other steam generators, heat exchangers, condensers and the like.

The reactions in the reformer train or steps, 104, produce a raw syngas, stream 105, which comprises hydrogen, carbon monoxide, carbon dioxide, water and methane or other unreacted hydrocarbon feed. Based on the reforming conditions, the raw syngas will usually be at high temperature, generally 800° C. or above, and at elevated pressure, up to about 50 bar, such as 15,20, 25 or 30 bar. The water content is usually high, typically as much as about 30%.

As in conventional syngas production, the raw gas is usually cooled, step 106, and passed through a separator, 107, where condensed water, stream 108, is removed. The dried raw syngas, stream 109, is sent as a feed stream to membrane step or unit, 110, containing membranes, 111, that are selectively permeable to carbon dioxide over hydrogen. In particular, the membranes typically have a selectivity for carbon dioxide over hydrogen of at least 5, and preferably at least about 15. The carbon dioxide permeance of the membrane is typically at least 200 gpu and, preferably, at least 400 gpu.

Any membrane with suitable performance properties may be used in the membrane separation step. The membrane may be made from inorganic or polymeric materials, and may take the form of a homogeneous film, an integral asymmetric membrane, a multilayer composite membrane, a membrane incorporating a gel or liquid layer or particulates, or any other form known in the art.

Representative preferred membranes have a selective layer based on a polyether. Such, materials are described, for example, in two publications by Lin et al., “Materials selection guidelines for membranes that remove CO₂ from gas mixtures” (J. Mol. Struct., 739, 57-75, 2005) and “Plasticization-Enhanced Hydrogen Purification Using Polymeric Membranes” (Science, 311, 639-642, 2006).

A specific preferred material for the selective layer is Pebax®, a polyamide-polyether block copolymer material described in detail in U.S. Pat. No. 4,963,165. We have found that membranes using Pebax® as the selective polymer can maintain a selectivity of 9, 10, or greater under process conditions.

The membranes may be manufactured as flat sheets or as fibers and housed in any convenient module form, including spiral-wound modules, plate-and-frame modules, and potted hollow-fiber modules. The making of all these types of membranes and modules is well-known In the art. In general, we prefer to use flat-sheet membranes and spiral-wound modules,

Membrane unit 110 may contain a single membrane module or bank of membrane modules or an array of modules. A single unit or stage containing one or a bank of membrane modules is adequate for many applications. If either the residue or permeate stream, or both, requires further carbon dioxide removal, it may be passed to a second bank of membrane modules for a second processing step. Such multi-stage or multi-step processes, and variants thereof, will be familiar to those of skill in the art, who will appreciate that the membrane separation step may be configured in many possible ways, including single-stage, multistage, multistep, or more complicated arrays of two or more units, in serial or cascade arrangements.

The membrane separation step can be operated by any mechanism that provides a driving force for transmembrane permeation. Most commonly, this driving force is provided by maintaining a pressure difference between the feed and permeate sides, or by sweeping the permeate side continuously with a gas that dilutes the permeating species, both of which techniques are well known in the membrane separation arts. FIG. 1 shows a simple pressure-driven case. The feed side of the membrane is typically maintained at a pressure within the range of about 5 bar to 50 bar, and more preferably within the range of about 15 bar to 30 bar. The permeate side is typically maintained at a pressure of about 10% to 30% of the feed side pressure, that is, about 1-10 bar.

Returning to FIG. 1, syngas stream 109 flows across the feed side of the membranes 111. A residue stream, 112, that is depleted in carbon dioxide relative to stream 109, is withdrawn from the feed side of the membrane. This stream forms the syngas product of the integrated process, and has a relatively high CO content compared with steam methane reforming performed without integrated membrane gas separation. Expressed as a ratio, the syngas product stream 112 has a CO:CO₂ ratio of at least about 3:1, preferably at least about 5:1 and most preferably at least about 6:1. Expressed as carbon monoxide concentration, the CO content is typically at least about 12%, preferably at least about 15% and most preferably at least about 20%.

The permeate stream, 113, is enriched in carbon dioxide compared with the membrane feed, and is recompressed in compression step or steps, 114, preferably to a pressure consistent with the reforming operations, and returned to the reformer as stream 115. Compression may be carried out in one or multiple steps as convenient.

FIG. 1 indicates that stream 115 is mixed with stream 102 before passing into the reformer train, as would be suitable if stream 115 were to be directed to the primary reforming reactor. In the alternative, stream 115 may be returned to another reactor, such as a secondary reforming reactor. The choice of where to return stream 115 can be readily made by the skilled person, depending on the particular balance of reactions that are being carried out.

The effect of returning the carbon-dioxide-rich stream 115 to the reformer is to suppress the CO₂-producing reactions and promotes the CO-producing reactions in the reformer, thereby increasing the CO yield and the ratio of CO to CO₂ in the syngas product.

Increasing the CO yield also tends to decrease the hydrogen:CO ratio in the syngas. As mentioned in the Summary section above, the processes of the invention are believed to be particularly beneficial in preparing syngas for use in gas-to-liquids processes, especially as feedstock for Fischer-Tropsch processes. In such gas-to-liquids conversions, it is desirable to use as feedstock a syngas with a low hydrogen:CO ratio, preferably below about 2.5:1 or .2.3:1, and most preferably closer to about 2.2:1 or 2.1:1. To facilitate obtaining a low hydrogen:CO ratio, it can be helpful to include a membrane separation step using membranes that are selective to hydrogen over carbon dioxide. This reduces the amount of hydrogen that is recycled to the reformer with the recovered carbon dioxide, enabling more effective CO₂ recycling as well as reducing the H₂:CO ratio in the product.

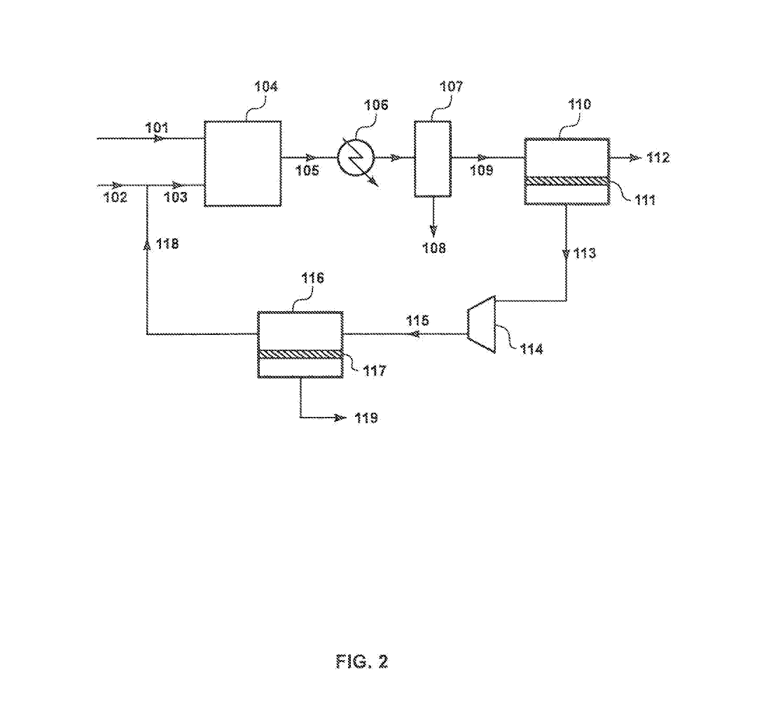

Such an embodiment is shown in FIG. 2, in which like elements are labeled as in FIG. 1 and are as described above. The process differs from the scheme shown in FIG. 1, however, in that stream 115 no longer passes to the reformer but instead is directed to a second membrane separation step or unit, 116, which uses membranes, 117, that are selective in favor of hydrogen over carbon dioxide and carbon monoxide. The membranes should preferably exhibit a selectivity for hydrogen over carbon dioxide of at least about 5, and more preferably at least about 10, a selectivity for hydrogen over carbon monoxide of at least about 10, and more preferably at least about 20, and a hydrogen permeance of preferably at least about 100 gpu, more preferably at least about 200 gpu.

As with the membranes selected for the first membrane separation step, any membranes with suitable performance properties may be used in the second membrane separation step. Once again, the membrane may be made from inorganic or polymeric materials, and may take the form of a homogeneous film, an integral asymmetric membrane, a multilayer composite membrane, a membrane incorporating a gel or liquid layer or particulates, or any other form known in the art.

Representative materials for the selective layer of the second membrane include polymers, such as polyimides, polyamides, polyurethanes, polyureas, polybenzimidazoles, and polybenzoxazoles; metals, such as palladium; zeolites; and carbon, by way of example and not by way of limitation.

Specific representative examples of suitable polymeric membrane materials include polybenzimidazole (FBI) based membranes, such as taught by K. O'Brien et al. in “Fabrication and Scale-Up of FBI-based Membrane System for Pre-Combustion Capture of Carbon Dioxide” (DOE NETL. Project Fact Sheet 2009) and polyimide-based membranes, such as taught by B. T. Low et al. in “Simultaneous Occurrence of Chemical Grafting, Cross-linking, and Etching on the Surface of Polyimide Membranes and Their Impact on H₂/CO₂ Separation” (Macromolecules. Vol. 41, No. 4, pp. 1297 - 1309, 2008).

Other choices with respect to the membrane and module format are generally as discussed above with respect, to the first process embodiment.

Returning to FIG. 2, compressed, CO₂-enriched stream 115 passes across membranes 117 under conditions that provide a driving force for transmembrane permeation. In the figure, this driving force is assumed to be provided by maintaining a pressure difference between the feed and permeate sides of the membrane unit, as described above. Hydrogen-enriched permeate stream, 119, is withdrawn from the process, and may be sent for recovery of purified hydrogen, for use as fuel, or tor any other desired use. Hydrogen-depleted residue stream, 118, is returned to the reforming steps.

The product, syngas stream, 112, generated by the process of FIG. 2, is typically characterized by both a high CO:CO₂ ratio, such as at least 3:1, 5:1 or 6:1, and a low hydrogen:CO ratio, such as below 3:1, 2.5:1, 2.3:1 or 2.2:1.

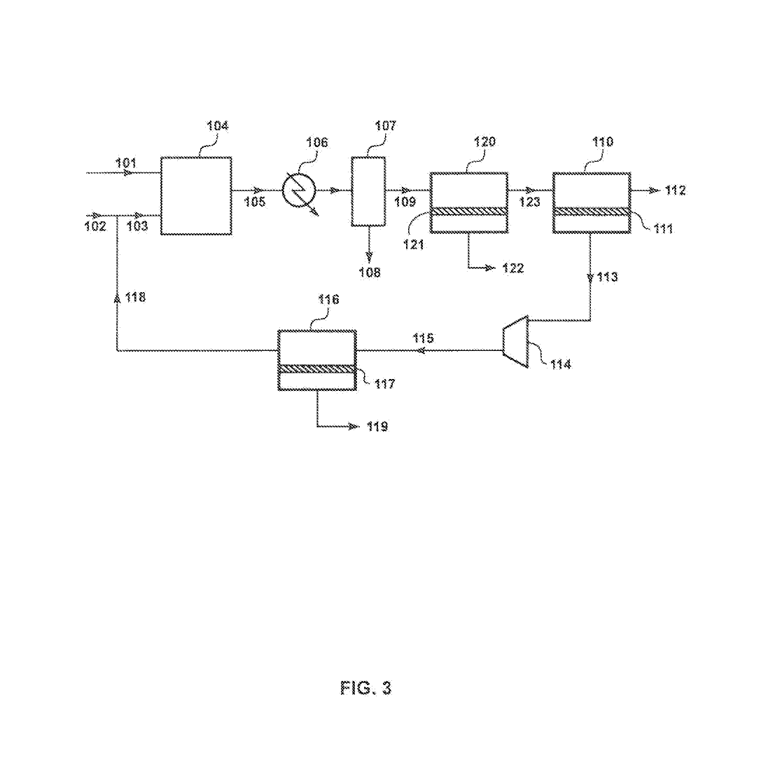

An alternative embodiment, suitable especially for achieving low hydrogen:CO ratios is shown in FIG. 3, with like elements again labeled as in the previous figures. Referring to FIG. 3, the process differs from the scheme of FIG. 2 in that a third membrane separation step, 120, is included. This step uses hydrogen-selective membranes, 121, and treats stream 109 before it is passed to membrane separation step 110. The considerations as to membrane types, operating conditions and preferred performance for membranes 121 are the same as for membranes 117. Typically, but not necessarily, the same membranes, such as inorganic membranes or polyimide membranes, are used in both steps 120 and 116.

Separation of stream 109 in unit or step 120 produces a hydrogen-depleted residue stream, 123, which is passed as the feed stream to the carbon-dioxide-selective step 110, and a hydrogen-rich permeate, stream 122, that is discharged from the process, and which may be directed to hydrogen purification, fuel or any other desired destination.

FIG. 1-3 illustrate embodiments in which the feed stream, 109, to membrane separation steps 110 and 120 is maintained at about the same pressure as the raw gas from the reformer, a lower pressure is maintained on the permeate side(s), and permeate stream, 113, is recompressed to a pressure suitable for reintroduction to the reforming steps. Such embodiments are preferred when the reformer operating pressure is above about 10 bar.

Another option is to compress stream 109 to a pressure higher than the reformer operating pressure, and to maintain the permeate side of membrane step or unit 110 at about the same pressure as the reformer, so that the permeate can be circulated to the reformer without the need for recompression. Such embodiments can be particularly useful if the raw syngas is at comparatively low pressure, by which we mean below about 10 bar, such as 5 bar.

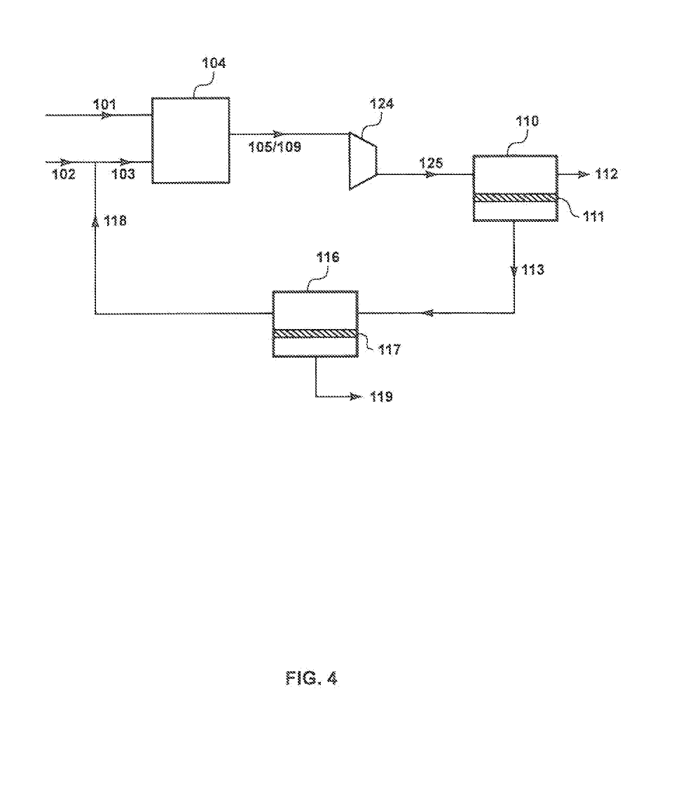

FIG. 4 shows such an embodiment as it relates to a process scheme similar to that of FIG. 2, in that the permeate, 113, from unit 110 is treated in unit 116 to remove excess hydrogen before being circulated back to the reforming steps. It will be apparent to those of skill in the art that arrangements in which membrane feed compression is used could also be readily applied to process schemes similar to those of FIGS. 1 and 3.

Referring to FIG. 4, compression step, 124, is used to compress raw syngas stream 105/109. For simplicity, the cooling and water knock-out steps are not shown in this figure, but typically cooling and resultant water condensation would take place both before and after step 124. Step 124 can be used to compress the raw syngas to any desired pressure, although generally the gas will be compressed to a few tens of bar, such as 15 bar, 20 bar, 25 bar or 30 bar. The compressed stream, 125, is then passed as feed to membrane separation step or unit 110.

In another aspect, the invention integrates membrane-based gas separation with gas-to-liquids processes, such as the Fischer-Tropsch (FT) process. The overall objective of gas-to-liquids technology is to convert methane or natural gas to heavier hydrocarbons (usually fractions that are easily transportable liquids at ambient temperature and pressure), that can be used as fuels, solvents, lubricants or the like. Methane is first broken down with steam or oxygen to form hydrogen and CO, then the CO and hydrogen are reacted to form hydrocarbons of the desired weight, either directly or via an intermediate synthesis.

In the Fischer-Tropsch process, for example, hydrogen and carbon monoxide are consumed, generally according to the overall scheme of reaction (7), repeated below, to yield a liquid hydrocarbon product or products of a desired weight.

nCO+(2n+1)H₂=CₙH₂ₙ₊₂+nH₂O (7)

Since the goal is to make mostly liquid products, the ideal stoichiometric ratios of hydrogen and carbon monoxide needed for the above synthesis will vary from an extreme of about 2.25, for a C4 product, to another extreme of about 2.08 for a C12 or 2.06 for a C15 product. The steam methane reforming reactions, however, tend to produce a syngas with a hydrogen:CO ratio of about 3 or more.

Integrating a membrane separation step provides ratio adjustment of the syngas and enables very high overall conversion of CO to liquid hydrocarbons. The membrane separation step can be integrated with the other steps either upstream or downstream of the hydrocarbon synthesis reactor(s).

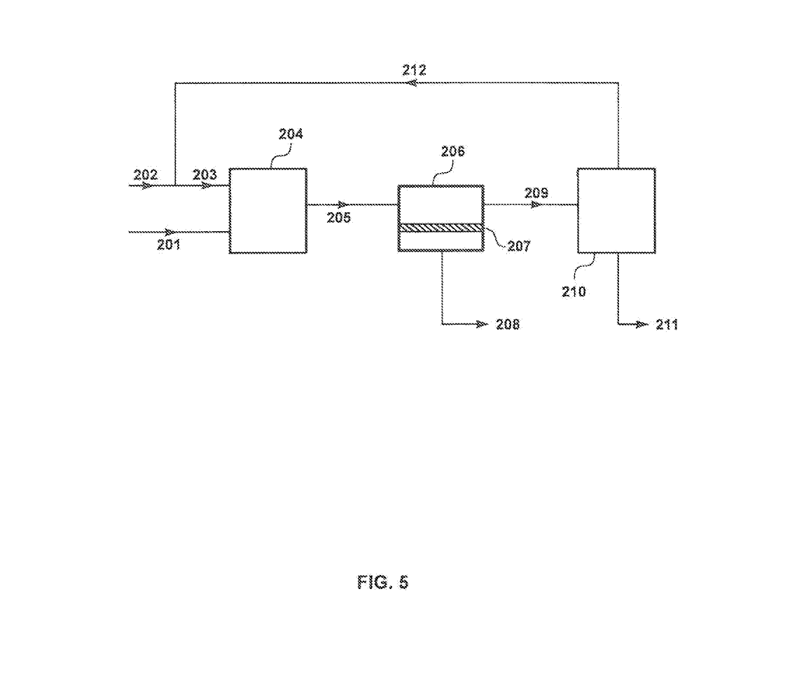

An embodiment in which the three operations are integrated with the membrane separation step on the inlet side of the hydrocarbon reactor is shown in FIG. 5. Referring to FIG. 5, steam, 201, is fed into a steam methane reforming step, 204, Methane or natural gas, stream 202, is combined with stream, 212, discussed below, and passed as feed stream, 203, to steam methane reformer 204, where reforming reactions take place as discussed with respect to the earlier embodiments.

The reactions form a raw syngas, stream 205. This stream, typically after cooling and water removal, as discussed previously, is passed as a feed stream to membrane separation step or unit, 206. In this embodiment, the membranes, 207, are selective in favor of hydrogen over carbon monoxide and carbon dioxide, preferably with a hydrogen/carbon dioxide selectivity of at least about 5, more preferably at least about 10, and a selectivity for hydrogen over carbon monoxide of at least about 10, more preferably at least about 20. Choices and operating conditions for the membranes and membrane unit are as discussed above with respect to the hydrogen-selective gas separation steps.

A permeate stream, 208, enriched in hydrogen compared with stream 205, is withdrawn as a hydrogen purge stream, and can be sent for fuel or other use. This stream typically contains at least about 90% hydrogen. Residue stream, 209, in which the hydrogen:CO ratio is preferably below about 2.3:1, and most preferably in the range 2.05-2.3, is passed to the hydrocarbon product synthesis and fractionation/purification train, shown together simply as element 210.

This train will usually include at least one reaction step, typically carried out in a fixed bed, fluidized bed or slurry reactor. Such reactors and operation thereof are well known in the art and are described in detail in, for example, S. T. Sie and R. Krishna, “Fundamentals and selection of advanced Fischer-Tropsch reactors”, Applied Catalysis A: General, Vol. 186 (1999) pages 55-70, and in A. P. Steynberg, “Chapter 2—Fischer-Tropsch Reactors”, Studies in Surface Science and Catalysis, Vol. 152 (2004), pages 64-195, both of which are incorporated herein by reference.

The raw product from the reactor usually contains a mix of paraffinic hydrocarbons of different weights, and can be passed to one or more fractionation steps to separate desired products from unreacted feedstock, light hydrocarbon byproducts, particularly methane, inerts and the like. The desired product(s) are withdrawn as stream 211.

The remaining lights, inerts and unreacted hydrogen and carbon monoxide form at least one tail gas stream, 212. Because excess hydrogen has been removed in stream 208, this tail gas is very lean in hydrogen compared with conventional tail gas streams. The stream is rich in methane, formed as a byproduct during GTL synthesis, and in carbon dioxide, as well as containing unreacted CO, and is returned to the steam reforming steps.

In this way, no carbon species are lost from the overall integrated process except for the very small amounts of carbon monoxide and dioxide contained in the hydrogen purge stream, and these usually represent no more than about 5% of the purge stream. As a result, the integrated process achieves high overall conversion of CO to products, such as 80%, 90% or above.

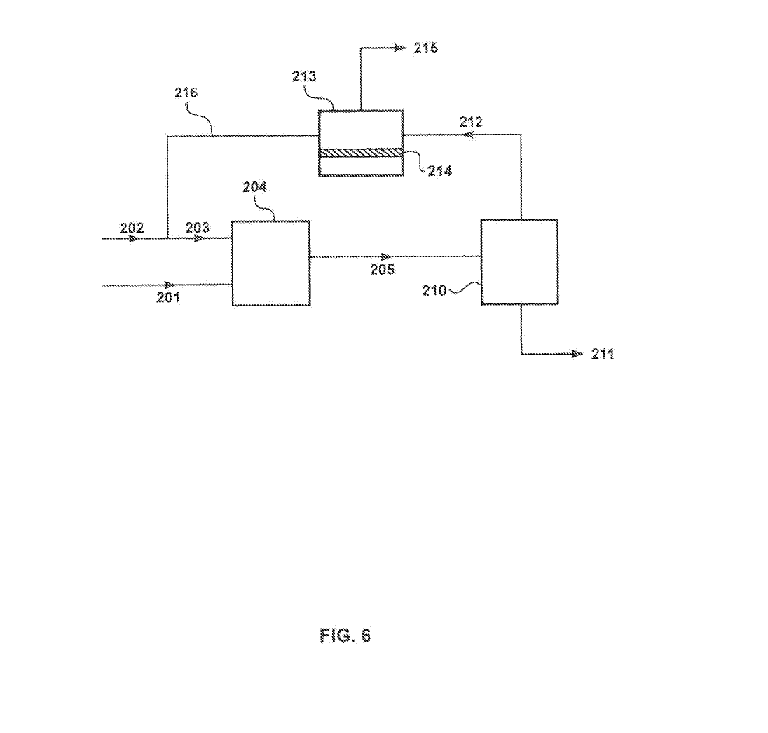

A second option is to position the hydrogen-selective membrane step(s) in the tail gas return line, as shown in FIG. 6. Referring to this figure, in which like elements are labeled as in FIG. 5, stream 205, usually after water removal, is passed to the liquids formation and purification steps, 210, without hydrogen removal. The tail gas stream, 212, forms the feed stream to membrane separation unit or steps, 213. For this step, membranes, 214, with hydrogen-selective properties and configurations as discussed above, are used. The step produces a hydrogen-rich permeate purge stream, 215, and an adjusted tail gas residue stream, 216, that is returned to the reforming steps. Preferences for overall operating conditions for the reforming, hydrocarbon synthesis, and membrane separation steps are as already discussed with respect to FIG. 5.

Once again, the process controls the amount of unwanted hydrogen that, is returned in the process loop, while recapturing most of the carbon species. Recycling of methane reduces the need to drive the reforming reactions with a excessively high temperature, since unreacted methane is not lost to the process.

The invention is now further described by the following examples, which are intended to be illustrative of the invention, but are not intended to limit the scope or underlying principles in any way.

### EXAMPLES

Calculation methodology: The computer calculations in all of the following Examples were performed using a modeling program, ChemCad 6.6 (Chem Stations, Inc., Houston, Tex.) which was modified with differential element subroutines for the membrane separation steps (as applicable). For all calculations, the carbon-dioxide-selective membrane was assumed to have CO₂/H₂ selectivity of 10, and CO₂/CO selectivity of 30, and the hydrogen-selective membrane was assumed to have H₂/CO₂ selectivity of 15, and H₂/CO selectivity of 30. The membrane separation steps were sized in each case to achieve a concentration of 3 mol % carbon dioxide in the product syngas.

### Example 1

### No Membrane Integration—Not in Accordance with the Invention

A base calculation was performed to model the output from a conventional steam reforming process without an integrated membrane separation step. This process is not in accordance with the invention, but serves as a comparative basis for the other calculations. The results of the calculation are shown in Table 1.

TABLE 1

| | Stream and stream number | | | |
|---|---|---|---|---|
| | Methane | | | Cooled |
| | feed | Steam feed | Stream from | syngas |
| | 102 | 101 | reformer 105 | 109 |
| Flow | 1,000 | 3,000 | 5,541 | 3,611 |
| (kmol/h) | | | | |
| Temp ° C. | 865 | 865 | 850 | 50 |
| Pressure (bar) | 28 | 27 | 25 | 25 |

Component Mol %

| | | | | |
|---|---|---|---|---|
| Carbon dioxide | 0 | 0 | 5.1 | 7.8 |
| Carbon monoxide | 0 | 0 | 8.8 | 13.5 |
| Hydrogen | 0 | 0 | 47.0 | 72.0 |
| Methane | 100.0 | 0 | 4.1 | 6.3 |
| Oxygen | 0 | 0 | 0 | 0 |
| Water | 0 | 100.0 | 35.1 | 0.4 |

According to the calculation, cooled syngas product stream 109 has a CD:CO₂ ratio of only 1.7 and an H₂:CO ratio of 5.3.

### Example 2

### Steam Reforming with One Carbon-Dioxide Selective Membrane Separation Step

A calculation was performed according to the process schematic of FIG. 1, in which a membrane gas separation step, using membranes selective in favor of carbon dioxide over carbon monoxide and hydrogen, is integrated with a steam methane reforming step. The results of the calculation are given in Table 2.

TABLE 2

| | Stream and stream number | | | | | |
|---|---|---|---|---|---|---|
| | | | | | Per- | |
| | Methane | Steam | Raw | Membrane | meate/ | Syngas |
| | Feed | Feed | Syngas | Feed | recycle | product |
| | 102 | 101 | 105 | 109 | 113 | 112 |
| Flow | 1,000 | 3,000 | 7,155 | 4,926 | 1,809 | 3,116 |
| (kmol/h) | | | | | | |
| Temp ° C. | 865 | 865 | 850 | 50 | 50 | 50 |
| Pressure | 28 | 28 | 25 | 25 | 7.0 | 25 |
| (bar) | | | | | | |

Component (mol %)

| | | | | | | |
|---|---|---|---|---|---|---|
| Carbon | 0 | 0 | 5.0 | 7.2 | 14.5 | 3.0 |
| dioxide | | | | | | |
| Carbon | 0 | 0 | 9.9 | 14.4 | 7.2 | 18.6 |
| monoxide | | | | | | |
| Hydrogen | 0 | 0 | 48.0 | 69.9 | 73.2 | 67.8 |
| Methane | 100.0 | 0 | 5.6 | 8.1 | 4.0 | 10.5 |
| Oxygen | 0 | 0 | 0 | 0 | 0 | 0 |
| Water | 0 | 100.0 | 31.5 | 0.4 | 1.1 | 0.1 |

Returning carbon dioxide to the reformer suppresses carbon dioxide production and increases CO yield, having a favorable effect on the both the CO:CO₂ and H₂:CO ratios in the syngas product The permeate/recycle stream, 113, contains 14.5 mol % carbon dioxide. The process can produce a syngas product, stream 112, containing only 3 mol % carbon dioxide, compared with almost 8 mol % in Example 1. The syngas product stream has a CO:CO₂ ratio of 6.2, compared with only 1.7 in Example 1, and an H₂:CO ratio of 3.6, compared with 5.3 in Example 1.

### Example 3

### Steam Reforming with Two Membrane Steps, as in FIG. 2

A calculation was performed according to the process scheme of FIG. 2, with two membrane gas separation steps, one using membranes selective in favor of carbon dioxide over CO and hydrogen, the other using membranes selective in favor of hydrogen over carbon dioxide, integrated with a steam methane reforming step. The carbon-dioxide selective membrane step is as described in Example 2, but the permeate 113 from that membrane is sent to second step with a hydrogen-selective membrane before being recycled to the reformer. The results of the calculation are given in Table 3.

TABLE 3

| | Stream and stream number | | | | | | | |
|---|---|---|---|---|---|---|---|---|
| | Methane | Steam | Raw | Membrane | | | Hydrogen | Syngas |
| | Feed | Feed | Syngas | Feed | Permeate | Recycle | Permeate | product |
| | 102 | 101 | 105 | 109 | 113 | 118 | 119 | 112 |
| Flow | 1,000 | 3,000 | 6,210 | 4,139 | 1,665 | 663 | 991 | 2,474 |
| (kmol/h) | | | | | | | | |
| Temp ° C. | 400 | 400 | 850 | 50 | 49 | 52 | 51 | 49 |
| Pressure | 30 | 30 | 25 | 25 | 5.0 | 25 | 3 | 25 |
| (bar) | | | | | | | | |

Component (mol %)

| | | | | | | | | |
|---|---|---|---|---|---|---|---|---|
| Carbon | 0 | 0 | 7.5 | 11.3 | 23.6 | 50.0 | 6.2 | 3.0 |
| dioxide | | | | | | | | |
| Carbon | 0 | 0 | 12.3 | 18.4 | 8.4 | 19.3 | 1.2 | 25.2 |
| monoxide | | | | | | | | |
| Hydrogen | 0 | 0 | 42.1 | 63.2 | 64.0 | 23.7 | 91.4 | 62.7 |
| Methane | 100.0 | 0 | 4.4 | 6.6 | 3.0 | 6.9 | 0.4 | 9.0 |
| Oxygen | 0 | 0 | 0 | 0 | 0 | 0 | 0 | 0 |
| Water | 0 | 100.0 | 33.7 | 0.5 | 0.1 | 0.1 | 0.8 | 0.1 |

The process produces a recycle stream 118 containing 50 mol % CO₂. The syngas product stream 112 has a CO:CO₂ ratio of 8.4 and an H₂:CO ratio of 2.5.

### Example 4

### Steam Reforming with Three Membrane Steps, as in FIG. 3

A calculation was performed according to the process scheme of FIG. 3, which uses three membrane gas separation steps. One of the steps uses membranes selective in favor of carbon dioxide over carbon monoxide and hydrogen, the other two steps use membranes selective in favor of hydrogen over carbon dioxide, integrated with a steam methane reforming step.

A third hydrogen-selective membrane step is added in front of the two membrane steps of Example 3. Instead of going directly to carbon-dioxide-selective step 110, raw syngas 109 is first subjected to membrane separation step 120, producing a hydrogen-depleted reside stream 123. Residue stream 123 is passed as the feed to carbon-dioxide-selective step 110.

Results of the calculation are given in Table 4. As can be seen, recycle stream 118 contains 50 mol % CO₂ as in Example 2, but the syngas product stream 112 has a CO:CO₂ ratio of 9.6 and an H₂:CO ratio of 2.1.

TABLE 4

| | Stream and stream number | | | | | | | | |
|---|---|---|---|---|---|---|---|---|---|
| | | | | | H2 | | | | |
| | CH4 | Steam | Membrane | Hydrogen | depleted | | H2 | | Syngas |
| | Feed | Feed | Feed | permeate | residue | Permeate | permeate | Recycle | product |
| | 102 | 101 | 109 | 122 | 123 | 113 | 119 | 118 | 112 |
| Flow | 1,000 | 3,000 | 4,167 | 417 | 3,750 | 1,592 | 896 | 689 | 2,157 |
| (kmol/h) | | | | | | | | | |
| Temp ° C. | 400 | 400 | 50 | 50 | 50 | 49 | 51 | 52 | 49 |
| Pressure | 30 | 30 | 25 | 3.0 | 25 | 5.0 | 3.0 | 25 | 5.0 |
| (bar) | | | | | | | | | |

Component (mol %)

| | | | | | | | | | |
|---|---|---|---|---|---|---|---|---|---|
| Carbon | 0 | 0 | 11.5 | 1.5 | 12.6 | 25.6 | 7.0 | 50.0 | 3.0 |
| dioxide | | | | | | | | | |
| Carbon | 0 | 0 | 18.7 | 1.3 | 20.7 | 9.7 | 19.3 | 20.5 | 28.8 |
| monoxide | | | | | | | | | |
| Hydrogen | 0 | 0 | 62.7 | 95.7 | 59.0 | 60.4 | 23.7 | 22.2 | 58.0 |
| Methane | 100.0 | 0 | 6.6 | 0.4 | 7.3 | 3.4 | 6.9 | 7.2 | 10.1 |
| Oxygen | 0 | 0 | 0.0 | 0 | 0 | 0 | 0.1 | 0 | 0 |
| Water | 0 | 100.0 | 0.5 | 1.1 | 0.4 | 0.9 | 0 | 0.1 | 0.1 |

### Example 5

### Steam Reforming with Compressed Membrane Feed and Two Membrane Steps, as in FIG. 4

A calculation was performed according to the process scheme of FIG. 4, in which the feed to the membrane separation step is compressed prior to entering the membrane separation unit. In this case, it was assumed that the reformer operates at 5 bar, and the membrane feed, stream 125, is compressed to 25 bar. The permeate side of membrane step or unit 110 was assumed to be maintained at 5 bar so that the permeate can be circulated to the reformer without the need for recompression. The results of the calculation are shown in Table 5.

TABLE 5

| | Stream and stream number | | | | | | | |
|---|---|---|---|---|---|---|---|---|
| | Methane | Steam | Raw | Membrane | | | Hydrogen | Syngas |
| | Feed | Feed | Syngas | Feed | Permeate | Recycle | permeate | product |
| | 102 | 101 | 105/109 | 125 | 113 | 118 | 119 | 112 |
| Flow | 1,000 | 3,000 | 6,715 | 4,139 | 2,443 | 1,632 | 811 | 1,977 |
| (kmol/h) | | | | | | | | |
| Temp ° C. | 400 | 400 | 650 | 50 | 48 | 48 | 51 | 47 |
| Pressure | 5.0 | 5.0 | 4.9 | 25 | 5.0 | 5.0 | 1.2 | 25 |
| (bar) | | | | | | | | |

Component (mol %)

| | | | | | | | | |
|---|---|---|---|---|---|---|---|---|
| Carbon | 0 | 0 | 14.4 | 21.9 | 37.0 | 50.0 | 11.0 | 3.0 |
| dioxide | | | | | | | | |
| Carbon | 0 | 0 | 7.7 | 11.7 | 5.4 | 7.6 | 0.8 | 19.5 |
| monoxide | | | | | | | | |
| Hydrogen | 0 | 0 | 34.4 | 52.3 | 50.4 | 33.0 | 85.6 | 54.7 |
| Methane | 100.0 | 0 | 9.0 | 13.6 | 6.3 | 8.9 | 1.0 | 22.8 |
| Oxygen | 0 | 0 | 0 | 0 | 0 | 0 | 0 | 0 |
| Water | 0 | 100.0 | 35.5 | 0.5 | 0.9 | 0.5 | 1.7 | 0 |

As can be seen, the syngas product stream 112 in this case has a CO:CO₂ ratio of 6.5 and an H₂:CO ratio of 2.8.

### Example 6

### Comparison of CO Yield With and Without Integrated Membrane Separation Steps

A series of modeling calculations was performed in the same manner as for Examples 1 and 2 to determine the carbon monoxide yield from a methane feedstock on a mole/mole conversion basis. The reforming temperature was varied from 650° C. to 850° C. The calculations were performed at reformer pressures of 5 bar and 25 bar.

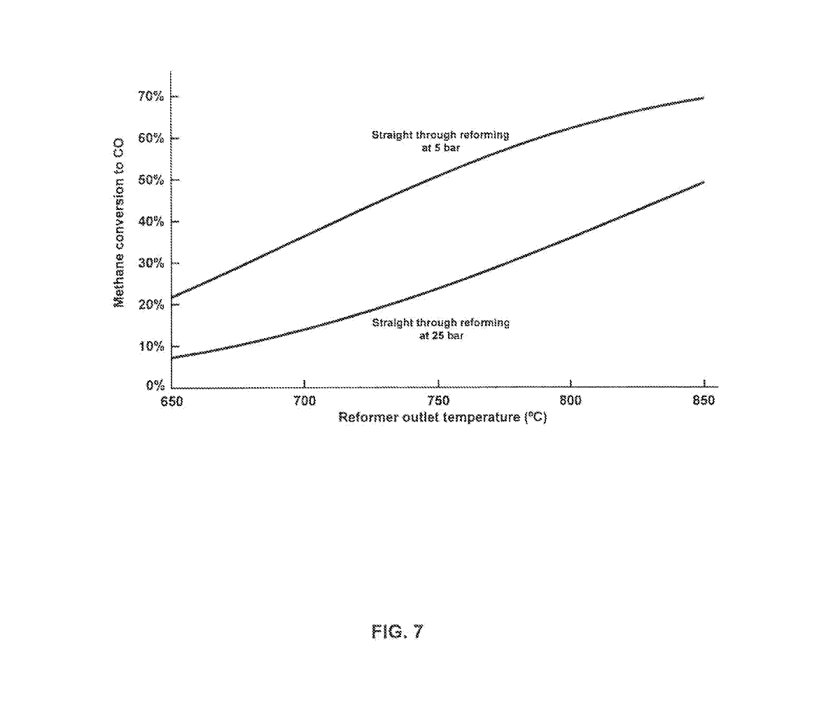

The first set of calculations assumed no membrane separation step. The results of these calculations are shown in FIG. 7, where percentage methane conversion to CO is plotted as a function of temperature. As can be seen, at a typical operating condition of 850° C. and 25 bar, a CO yield of about 50% can be obtained.

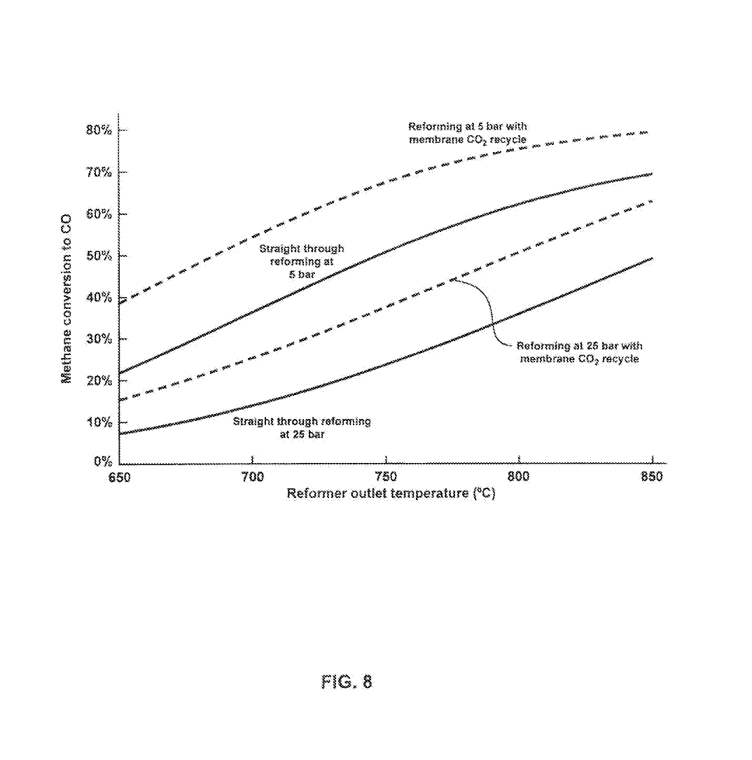

The second set of calculations assumed a configuration like that of Example 2 and FIG. 1, using a carbon-dioxide-selective membrane. The results of these calculations are shown in FIG. 8. As can be seen, for all sets of operating conditions, integration of membrane separation with steam methane reforming provides a process that outperforms the conventional reforming process.

We claim:

1. A process for the production, of syngas comprising the following steps:
(a) reacting a gas mixture comprising steam and methane in a reformer train to form a raw syngas stream comprising hydrogen, carbon monoxide and carbon dioxide;
(b) providing a membrane having a feed side and a permeate side, wherein the membrane exhibits a selectivity to carbon dioxide over hydrogen;
(c) passing at least a portion of the raw syngas stream as a feed stream across the feed side;
(d) withdrawing from the feed side a syngas product stream depleted in carbon dioxide compared with the feed stream, the syngas product stream containing carbon monoxide and carbon dioxide in a CO:CO₂ molar ratio of at least about 3:1;
(e) withdrawing from the permeate side a permeate stream enriched in carbon dioxide compared with the feed stream;
(f) returning at least a portion of the permeate stream as a feedstock to the reformer train.

2. The process of claim 1, further comprising cooling the raw syngas stream before carrying out step (c).

3. The process of claim 1, further comprising compressing the portion of the permeate stream before carrying out step (f).

4. The process of claim 1, further comprising compressing the raw syngas stream before carrying out step (c).

5. The process of claim 1, wherein the membrane exhibits a selectivity to carbon dioxide over hydrogen of at least about 5.

6. The process of claim 1, wherein the syngas product stream is passed as a feedstock stream to a Fischer-Tropsch process.

7. The process of claim 1, wherein the CO:CO₂ molar ratio is at least about 5:1.

8. The process of claim 1, wherein the CO:CO₂ molar ratio is at least about 6:1.
